(19) United States
(12) Patent Application Publication
(10) Pub. No.: US 2010/0005858 A1
(43) Pub. Date: Jan. 14, 2010

(54) Polyaniline Nanofiber-Metal Salt Composite Materials for Arsine Detection

(76) Inventors: Shabnam Virji, Yorba Linda, CA (US); Robert Kojima, Los Angeles, CA (US); Richard B. Kaner, Pacific Palisades, CA (US); Bruce H. Weiller, Santa Monica, CA (US)

Correspondence Address: HENRICKS SLAVIN AND HOLMES LLP;SUITE 200, 840 APOLLO STREET, EL SEGUNDO, CA, 90245, US

(21) Appl. No.: 12/173,011

(22) Filed: Jul. 14, 2008

(51) Int. Cl. G01N 27/12

(52) U.S. Cl. 73/31.05

(57) ABSTRACT

A sensor for detecting arsine includes a pair of electrodes separated by an electrode gap, and a layer of conducting polymer material positioned over and making electrical contact with the pair of electrodes, the layer of conducting polymer material being modified with a metal salt such that the electrical resistance of the conducting polymer material measured across the electrodes is responsive to changes in an amount of arsine to which the conducting polymer material is exposed.

### TECHNICAL FIELD

The invention relates generally to sensors for detecting gases and, in particular, to sensors with polyaniline nanofiber-metal salt composite materials for detecting arsine.

### BACKGROUND ART

Arsine, AsH₃, is a flammable, pyrophoric, and highly toxic gas, which has been used in the semiconductor industry and for the synthesis of organoarsenic compounds. Human exposure to arsine can result in acute arsine toxicity, namely, sudden extensive hemolysis (destruction of red blood cells). Inhalation of 250 ppm (800 mg/m³) of arsine gas is instantly lethal. Exposures of 25-50 ppm (80-160 mg/m³) for one-half hour are lethal, and 10 ppm (32 mg/m³) is lethal after longer exposures. Most cases of arsine poisoning have been associated with the use of acids and crude metals, one or both of which contained arsenic as an impurity. Moreover, some coal contains significant amounts of arsenic, and processes for converting coal to gas and other by-products potentially result in the transformation of arsenic impurities into arsine.

Conducting polymers, such as polyaniline, have been widely studied as chemical sensors due to their simple and reversible acid doping and base dedoping chemistry. Polyaniline is a conducting polymer that has been widely studied for electronic and optical applications. Unlike other conjugated polymers, polyaniline has a simple and reversible acid doping and base dedoping chemistry enabling control over properties such as free-volume, solubility, electrical conductivity, and optical activity. In recent years, one-dimensional polyaniline nanostructures, including nano-wires, rods, and tubes have been studied with the expectation that such materials will possess the advantages of both low-dimensional systems and organic conductors. The change in conductivity associated with the transition from the insulating emeraldine base to the conducting emeraldine salt form of polyaniline is over ten orders of magnitude. This wide range in conductivity has been utilized to make polyaniline sensors that can detect either acids or bases. Polyaniline is one of the most widely studied conducting polymers because of polyaniline environmental stability and straightforward synthesis. Polyaniline is a useful material for chemical sensors because polyaniline conductivity can change in the presence of doping and dedoping agents. In the undoped state, insulating emeraldine, polyaniline is an interesting material for chemical sensors because the conductivity can increase by over ten orders of magnitude on exposure to doping acids. This process can be reversed by dedoping in the presence of bases.

It would be useful to be able to provide a chemical sensor for detecting arsine using a conductive polymer such as polyaniline and/or a nanofiber material.

### SUMMARY OF THE INVENTION

Embodiments described herein utilize metal salt modified polyaniline nanofiber composite materials (e.g., films) for arsine detection. The detection mechanism involves reduction of arsine by the metal salt to produce an acid that dopes polyaniline resulting in a resistance change in the film that is related to the pKₐ of the acid generated and the metal salt used. The synthesis of polyaniline nanofiber composite films and their applications as arsine sensors are also described.

In an example embodiment, a thin film of polyaniline nanofiber/metal salt composite film is formed on a set of electrodes by evaporation from an aqueous suspension of polyaniline nanofibers with metal salt additives. When exposed to arsine gas (500 ppb) the conductivity of the polyaniline nanofiber/metal salt composite film increases by 2 orders of magnitude. The metal salt, CuBr₂ reduces the arsine and forms a strong acid byproduct. The strong acid, such as HBr, then dopes the polyaniline converting it from the emeraldine base state to the emeraldine salt state increasing its conductivity. In this case, an acid is generated indirectly doping polyaniline and changing its conductivity. The unique property of this mechanism is the dependence on the response of the film to the pKₐ of the acid. The lower the pKₐ of the acid, the more it dopes polyaniline resulting in a larger conductivity change of the film. This mechanism is also dependent on the metal salt used. Some metals catalyze the reduction of arsine faster than others.

In an example embodiment, a sensor for detecting arsine includes a pair of electrodes separated by an electrode gap, and a layer of conducting polymer material (e.g., polyaniline material) positioned over and making electrical contact with the pair of electrodes, the layer of conducting polymer material being modified with a metal salt such that the electrical resistance of the conducting polymer material measured across the electrodes is responsive to changes in an amount of arsine to which the conducting polymer material is exposed.

In an example embodiment, a sensor for detecting arsine includes a pair of electrodes separated by an electrode gap, and a layer of polyaniline nanofiber composite material (e.g., in the form of a film) positioned over and making electrical contact with the pair of electrodes, the layer of polyaniline nanofiber composite material being modified with a metal salt such that the electrical resistance of the polyaniline nanofiber composite material measured across the electrodes is responsive to changes in an amount of arsine to which the polyaniline nanofiber composite material is exposed.

### BRIEF DESCRIPTION OF THE DRAWINGS

FIG. 1 shows an Energy Dispersive X-Ray (EDX) spectrum of copper bromide polyaniline nanofiber composite film after exposure to arsine;

FIG. 2 is a plot showing responses of unmodified polyaniline nanofiber and metal salt/polyaniline nanofiber composite films exposed to arsine (in this case, MLₙ is CuBr₂, the AsH₃ concentration is 500 ppb and the humidity is 50% RH at room temperature);

FIG. 3 shows an example reaction mechanism of the response of metal salt/polyaniline nanofiber composite film exposed to arsine;

FIG. 4 is a plot showing responses of unmodified and metal salt modified polyaniline nanofiber films exposed to 500 ppb arsine at room temperature with 50% relative humidity;

FIG. 5 is a plot showing responses of different metal salt modified polyaniline nanofiber films exposed to 1 ppm arsine at room temperature with 50% relative humidity; and

FIG. 6 illustrates an example embodiment of an arsine sensor including polyaniline nanofiber-metal salt composite materials.

### DISCLOSURE OF INVENTION

Polyaniline nanofibers suitable for the arsine sensors described herein can be synthesized, for example, using the interfacial polymerization technique. See, Polyaniline Nanofiber Composites with Metal Salts: Chemical Sensors for Hydrogen Sulfide, Virji, S.; Fowler, J. D.; Baker, C. O.; Huang, J.; Kaner, R. B.; Weiller, B. H., Small 2005, 1(6), 624-627.

In an example embodiment, the nanofibers were modified with metal salts by adding 0.01 M metal salt solution to the aqueous polyaniline nanofiber dispersion in a ratio of 1:5 by volume. Suitable metal salts include, by way of example, copper bromide, copper chloride, copper nitrate, europium chloride, cobalt chloride, nickel chloride, and iron chloride. In an example embodiment, gold interdigitated electrode sensor arrays with 20 μm electrode gaps were used as the sensor substrates. The films were made by drop casting the solution on the electrodes and drying the film in air. A Keithley 2002 multimeter was used to measure the sensor electrical resistances. Mass flow controllers directed the flow of calibrated gas mixtures into the cell. A bubbler with water was used to generate humidity that was measured with a humidity sensor.

Occupational Safety and Health Administration (OSHA) sets enforceable Permissible Exposure Limits (PELs) to protect workers against the health effects of exposure to hazardous substances. PELs are regulatory limits on the amount or concentration of a substance in the air. They may also contain a skin designation.

Immediately Dangerous to Life and Health (IDLH) is defined by the National Institute for Occupational Safety and Health (NIOSH) as exposure to airborne contaminants that is “likely to cause death or immediate or delayed permanent adverse health effects or prevent escape from such an environment.”

Arsine is a highly toxic chemical that is widely used in the semiconductor industry, with exposure limits of PEL=63 ppb and an IDLH=3 ppm. These low limits make it very challenging to detect by unmodified polyaniline. The metal salt-polyaniline nanofiber composite films as described herein can be used (and have been observed) to detect arsine at levels lower than the PEL.

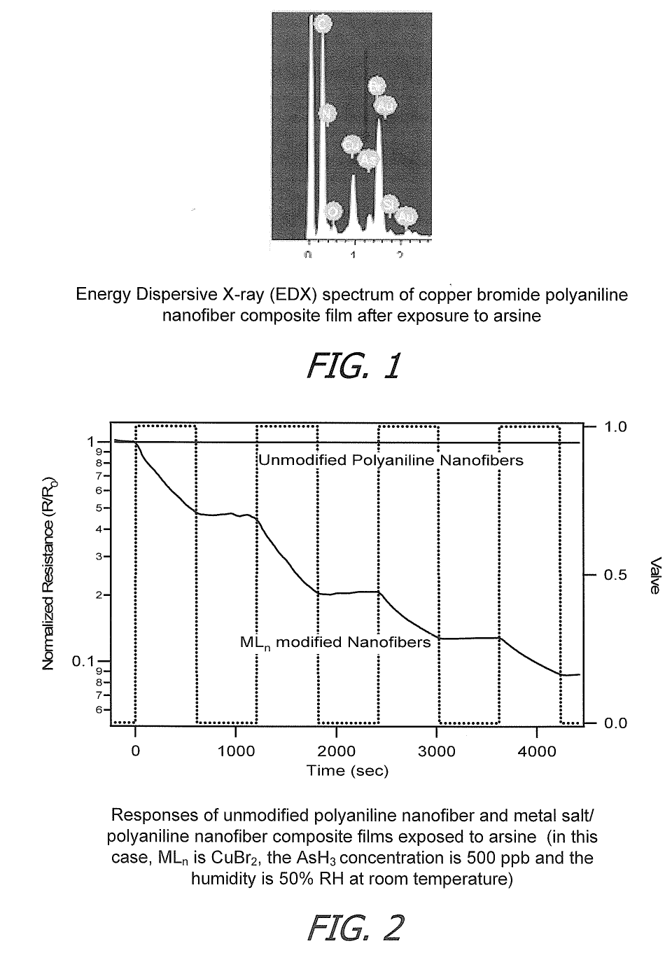

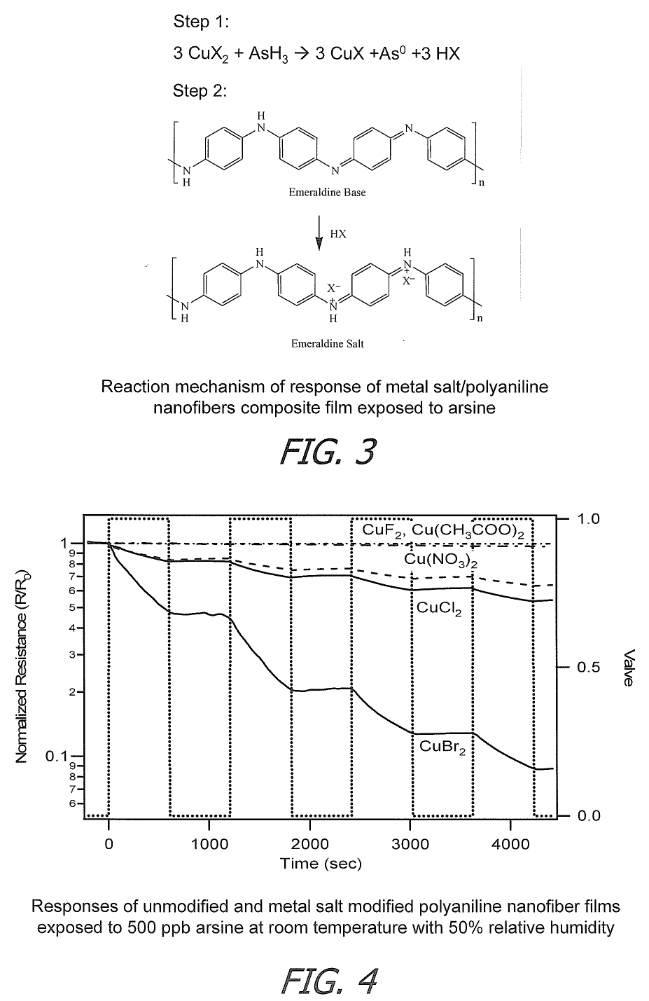

Upon examination of these films with EDX, referring to FIG. 1, formation of arsine that was not present before exposure of the film can be seen. FIG. 2 shows the response curve of an example metal salt-polyaniline nanofiber composite film. In an example embodiment, a sensor for detecting arsine functions similar to a dosimeter, doping the polyaniline, with arsine detection limits well below the IDLH level, while the unmodified polyaniline nanofibers show no response to arsine. In FIG. 2, the left axis is the normalized resistance, that is, the time change in resistance of the film divided by the initial resistance of the film, the bottom axis is time, and the right axis is the valve turning on (1.0) and off (0.0). FIG. 3 shows a possible reaction mechanism. As seen from the mechanism, the metal salt (CuX₂, X═Cl⁻, Br⁻), reduces arsine and generates an acid, HX. This acid can then dope the polyaniline nanofibers reducing its resistance, as seen in FIG. 2.

The acidity of the acid, HX also affects the response of the composite film to arsine. FIG. 4 shows the response of different copper salt-modified polyaniline nanofibers exposed to arsine. Copper bromide produces the acid HBr, copper chloride (HCl), copper fluoride (HF), copper nitrate (HNO₃), and copper acetate (CH₃COOH). The pKₐ values of these acids are listed in Table 1. Out of these acids HBr is the most acidic and CH₃COOH is the weakest acid, with a pKₐ that is just low enough to dope polyaniline, any acid that has a pKₐ higher than this value will not dope polyaniline. As seen from the figure, copper fluoride and copper acetate modified polyaniline nanofibers show no response to arsine. The acids generated, HF and CH₃COOH, are weak acids and do not dope polyaniline well. Copper bromide produces the strongest response and copper chloride and copper nitrate modified polyaniline nanofibers show similar responses. The neat metal salts alone, without the polyaniline nanofiber network, do not react with arsine. The polyaniline material is an essential part to the sensing mechanism. It should be understood that the principles described herein are not limited to polyaniline nanofiber materials and, for example, are applicable to conducting polymer materials in general. Other examples of conducting polymers are polypyrrole, polythiophene, etc.

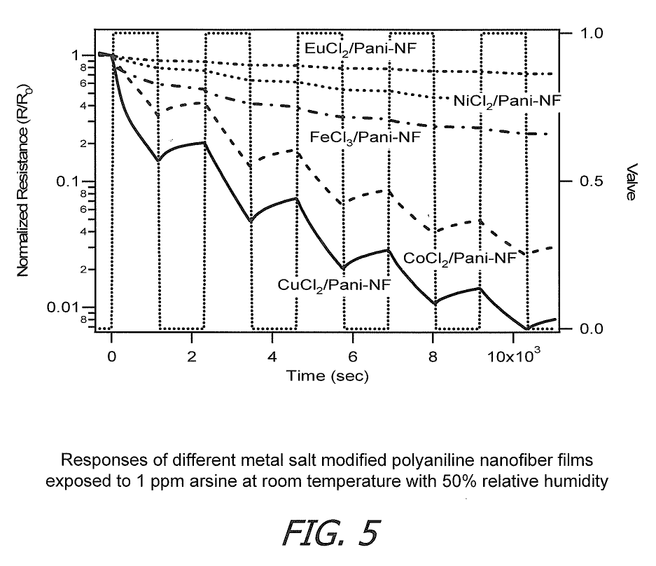

Other metal salts can also be used to detect arsine such as europium chloride, cobalt chloride, nickel chloride and iron chloride, but the response is much smaller than that for copper chloride (FIG. 5). This shows that the metal catalyzed oxidation of arsine is dependent on the metal.

TABLE 1
pKₐ values of some acids.

| Acid | PKₐ |
|---|---|
| HBr | −9.00 |
| HCl | −8.00 |
| HNO₃ | −1.30 |
| HF | +3.17 |
| CH₃COOH | +4.756 |

The sensing technique described above facilitates extremely sensitive arsine detection. Potential uses include, but are not limited to, homeland security, industrial safety and process monitoring.

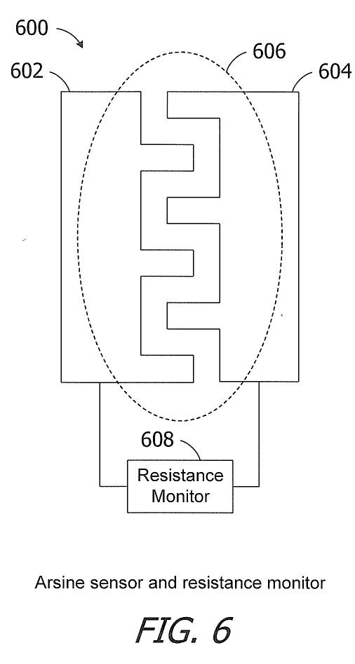

Referring to FIG. 6, in an example embodiment, a sensor 600 includes a pair of electrodes 602 and 604, and a layer 606 of metal salt modified polyaniline nanofiber composite material (shown in dashed lines) positioned over and contacting the electrodes 602 and 604. In this example embodiment, the electrodes 602 and 604 are interdigitated as shown. The electrodes 602 and 604 are formed of a conductive material, such as gold. As noted above, in an example embodiment, the gap between the electrodes is approximately 20 μm.

In this example embodiment, the sensor 600 also includes a resistance monitor 608 connected across the electrodes 602 and 604 for measuring the resistance of the layer 606 of metal salt modified polyaniline nanofiber composite material as it changes in response to the metal salt modified polyaniline nanofiber composite material being exposed to arsine.

Although the present invention has been described in terms of the example embodiments above, numerous modifications and/or additions to the above-described embodiments would be readily apparent to one skilled in the art. It is intended that the scope of the present invention extend to all such modifications and/or additions.

1. A sensor for detecting arsine, the sensor comprising:
a pair of electrodes separated by an electrode gap; and
a layer of conducting polymer material positioned over and making electrical contact with the pair of electrodes, the layer of conducting polymer material being modified with a metal salt such that the electrical resistance of the conducting polymer material measured across the electrodes is responsive to changes in an amount of arsine to which the conducting polymer material is exposed.

2. The sensor of claim 1, further comprising:
a resistance monitor electrically connected across the electrodes.

3. The sensor of claim 1, wherein the electrodes are interdigitated.

4. The sensor of claim 1, wherein the electrodes are made of gold.

5. The sensor of claim 1, wherein the electrode gap is approximately 20 μm.

6. The sensor claim 1, wherein the conducting polymer is polyaniline, polypyrrole, or polythiophene.

7. The sensor of claim 1, wherein the conducting polymer material includes nanofibers.

8. The sensor of claim 1, wherein the conducting polymer material is a film.

9. The sensor of claim 1, wherein the metal salt is water soluble.

10. The sensor of claim 1, wherein the metal salt is copper bromide.

11. The sensor of claim 1, wherein the metal salt is copper chloride.

12. The sensor of claim 1, wherein the metal salt is copper nitrate.

13. The sensor of claim 1, wherein the metal salt is europium chloride.

14. The sensor of claim 1, wherein the metal salt is cobalt chloride.

15. The sensor of claim 1, wherein the metal salt is nickel chloride.

16. The sensor of claim 1, wherein the metal salt is iron chloride.

17. A sensor for detecting arsine, the sensor comprising:
a pair of electrodes separated by an electrode gap; and
a layer of polyaniline nanofiber composite material positioned over and making electrical contact with the pair of electrodes, the layer of polyaniline nanofiber composite material being modified with a metal salt such that the electrical resistance of the polyaniline nanofiber composite material measured across the electrodes is responsive to changes in an amount of arsine to which the polyaniline nanofiber composite material is exposed.

18. The sensor of claim 17, further comprising:
a resistance monitor electrically connected across the electrodes.

19. The sensor of claim 17, wherein the electrodes are interdigitated.

20. The sensor of claim 17, wherein the electrodes are made of gold.

21. The sensor of claim 17, wherein the electrode gap is approximately 20 μm.

22. The sensor of claim 17, wherein the polyaniline nanofiber composite material is a film.

23. The sensor of claim 17, wherein the metal salt is water soluble.

24. The sensor of claim 17, wherein the metal salt is copper bromide.

25. The sensor of claim 17, wherein the metal salt is copper chloride.

26. The sensor of claim 17, wherein the metal salt is copper nitrate.

27. The sensor of claim 17, wherein the metal salt is europium chloride.

28. The sensor of claim 17, wherein the metal salt is cobalt chloride.

29. The sensor of claim 17, wherein the metal salt is nickel chloride.

30. The sensor of claim 17, wherein the metal salt is iron chloride.
